(19) United States
(12) Patent Application Publication
(10) Pub. No.: US 2008/0054651 A1
(43) Pub. Date: Mar. 6, 2008

(54) HANDLESET MECHANISM WITH REDUCED THUMB LATCH FORCE

(76) Inventors: Graham Wheatland, Rancho Santa Margarita, CA (US); Elena Gorkovenko, Mission Viejo, CA (US)

Correspondence Address: CARLSON, GASKEY & OLDS, P.C., 400 WEST MAPLE ROAD, SUITE 350, BIRMINGHAM, MI, 48009, US

(21) Appl. No.: 11/872,067

(22) Filed: Oct. 15, 2007

Related U.S. Application Data
(62) Division of application No. 11/088,108, filed on Mar. 23, 2005.

(51) Int. Cl. E05B 3/00

(52) U.S. Cl. 292/336.3

(57) ABSTRACT

A handleset mechanism of the sort having a pivoting thumb latch and a rotary handle is provided with a force transmission path to generally improve the actuation by the thumb latch and reduce the required force. One feature is a heart-shaped cam that communicates movement between a spindle driven by the rotary handle, and a slider plate driven by the thumb latch. By using the cam, the force required by the thumb latch is reduced. Another feature is the provision of a curved surface between the thumb latch and the slider plate. Further, in one embodiment, the rotary handle can be actuated without any corresponding movement of the thumb latch.

This application is a divisional of U.S. patent application Ser. No. 11/088,108, which was filed Mar. 23, 2005.

### BACKGROUND OF THE INVENTION

This invention relates to a handleset of the sort having a rotating handle on one side, and a pivoting thumb latch on another. Several improvements in this basic type handleset are provided by the inventive design.

Handlesets are utilized to control the opening and closing of door latches. There are many combinations of actuation systems on the two sides of any handleset. As an example, some handlesets have rotating handles on both sides.

One other type of handleset utilizes a rotating handle on one side, and a pivoting thumb latch on the other. The pivoting thumb latch is often utilized on an outside side of a door with the rotating handle on an inner side of the door.

To date, the force required to actuate the thumb latch has been undesirably high. It would be desirable to reduce this force. Further, it would be desirable to provide a more robust handleset than presently available.

### SUMMARY OF THE INVENTION

In a disclosed embodiment of this invention, a handleset mechanism has a pivoting thumb latch on one side, and a rotating handle on the other. A force transmission path for actuation by the thumb latch passes through a cam. The cam rotates to in turn rotate a spindle that opens the latch. In one disclosed embodiment, the cam has a generally heart shape.

In other features of this invention, an interface between the thumb latch and a slide, which moves when the thumb latch is actuated, is curved, to provide a smoother force transmission path.

In one embodiment of this invention, the rotating handle can be turned without corresponding movement of the thumb latch. This is desirable in that it is sometimes undesirable to have the latch pivoting when the door handle is being turned. To achieve this feature, the spindle is provided of two parts.

These and other features of the present invention can be best understood from the following specification and drawings, the following of which is a brief description.

### BRIEF DESCRIPTION OF THE DRAWINGS

FIG. 1 is a perspective view of a handleset mechanism.

FIG. 2 is an exploded view of the FIG. 1 handleset mechanism.

FIG. 3 is a perspective view of one component.

FIG. 4A is a cross-sectional view in the unactuated position.

FIG. 4B is a cross-sectional view in an actuated position.

FIG. 5A is a cross-sectional view along lines 5A-5A of FIG. 4A.

FIG. 5B is a cross-sectional view along lines 5B-5B of FIG. 4B.

FIG. 6 shows a second embodiment in exploded view.

FIG. 7 is a perspective view of one portion of the FIG. 6 embodiment.

FIG. 8A is a view similar to FIG. 4A, however showing the FIG. 6 embodiment.

FIG. 8B is a view similar to FIG. 4B, however showing the FIG. 6 embodiment.

FIG. 9A is a cross-sectional view along line 9A-9A of FIG. 8A.

FIG. 9B is a cross-sectional view along line 9B-9B of FIG. 8B.

FIG. 10A is a cross-sectional view along line 10A-10A of FIG. 8A.

FIG. 10B is a cross-sectional view along line 10B-10B of FIG. 8B.

### DETAILED DESCRIPTION OF THE PREFERRED EMBODIMENT

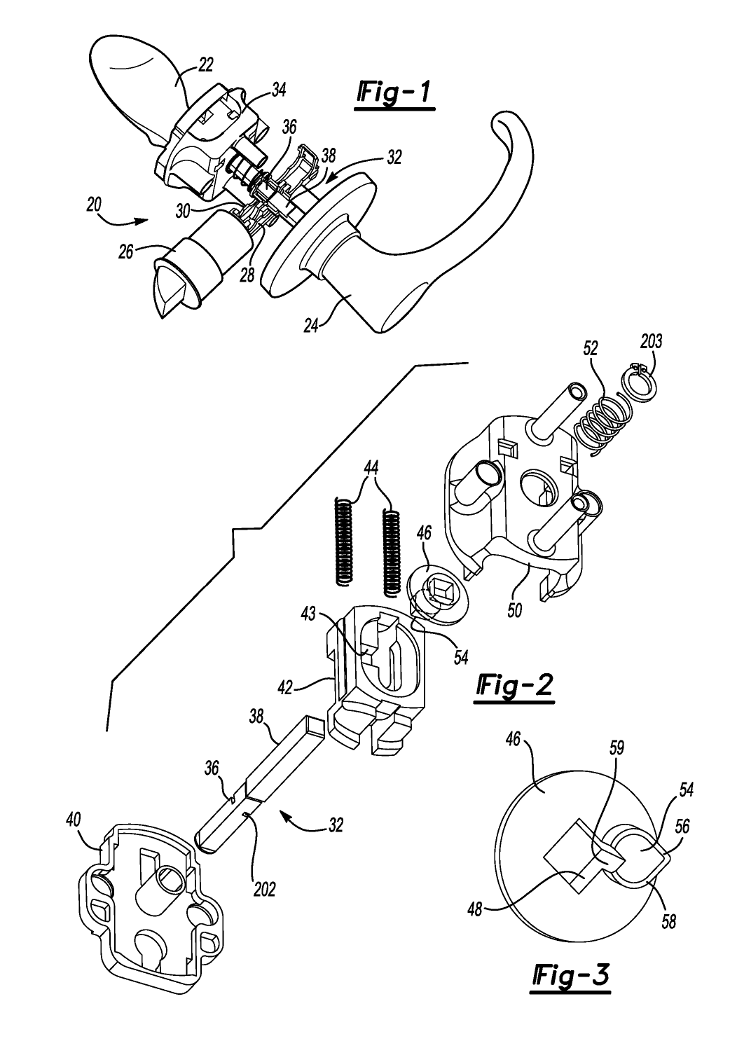

A handleset mechanism 20 is illustrated in FIG. 1. A thumb latch 22 is mounted on one side with a rotating handle 24 on the other. Actuation of either the thumb latch 22 or the handle 24 will cause a latch 26 to be actuated to allow a door to be opened. A spindle 32 is provided with two sections 36 and 38, which each respectively cause actuation of a hub 30 and 28. The hubs 30 and 28 open a latch 26 as known in the art. An actuation mechanism 34 for transmitting actuation movement of either the thumb latch 22 or the handle 24 is the inventive aspect of this invention.

As shown in FIG. 2, in exploded view, actuation mechanism 34 includes a cover plate 40, a slider plate 42 and springs 44 that bias slider 42 to an unactuated position. A slot 43 is formed within the slider plate 42.

A rotary plate 46 includes a central bore 48, and a cam 54. A spring 52 is mounted onto the spindle 32 and biases it to be in contact with the hubs. A groove 202 receives a snap ring 203 to lock the spring and generate the bias force. When spindle 32 is rotated to its unactuated position, it keeps handle 24 in an unactuated position. An outer cover plate 50 encloses the structure.

As shown in FIG. 2, the spindle 32 has two distinct portions 36 and 38. As will be shown below, portion 38 fits within portion 36 and can rotate the two portions relative to each other.

As shown in FIG. 3, the rotary plate 46 has cam 54 with two curved surfaces 56 and 58. A cut-out 59 in the cam 54 forms a portion of the bore 48. It could be said the cam 54 is generally heart-shaped.

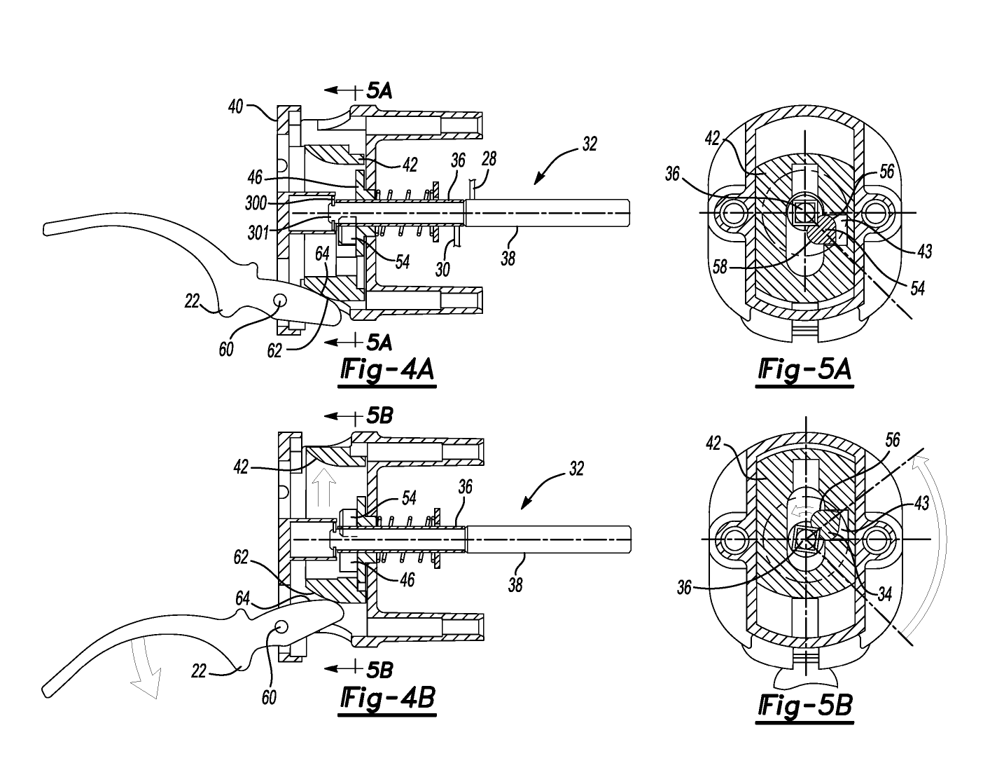

FIG. 4A shows the thumb latch 22 pivoting on a pin 60 within the cover 40. A lower surface 62 of the slider plate 42 engages an upper surface 64 of the thumb latch 22. The surfaces 62 and 64 are both curved, such that when the latch 22 is pivoted downwardly, as shown in FIG. 4B, to in turn move the slider plate 42 upwardly, the surfaces 62 and 64 provide a relatively smooth force transmission path. As is clear from the Figures, the curved contact surfaces on the thumb latch and the slider plate are curved about radii that are perpendicular to a pivot axis of said thumb latch. As such, the two surfaces move relative to each other as the thumb latch moves.

As shown in FIGS. 5A and 5B, when the slider plate 42 is in the unactuated position of FIG. 4A, the cam 54 sits within slot 43. One curved surface 58 sits on an end wall of the slot 43. When the thumb latch 22 is actuated such as shown in FIG. 4B, it forces slider plate 42 upwardly. As slider plate 42 moves upwardly, rotary plate 46 is driven to turn by the slot 43 driving the cam 54. As rotary plate 46 is driven to rotate, it in turn rotates spindle portion 36. When portion 36 rotates, it actuates the latch 26 through hub 30, again through a known mechanism. The thumb latch is movable between an actuated (FIG. 5B) and an unactuated (FIG. 5A) position by pivoting. A surface on the slider plate is in contact with the cam when the thumb latch is in the unactuated position such that initial movement of said thumb latch to the actuated position causes immediate movement of the slider plate and the cam.

If the door handle 24 is actuated, it will turn spindle portion 38 and open the latch 26 through hub 28. When this occurs, the rotary plate 46 will not rotate since the portion 38 can rotate within the portion 36. Thus, the thumb latch 22 will not pivot.

With this embodiment, should someone be actuating the door handle, the latch mechanism will not be caused to pivot. This would provide benefits, such as the external thumb latch not being actuated when someone leaves from inside.

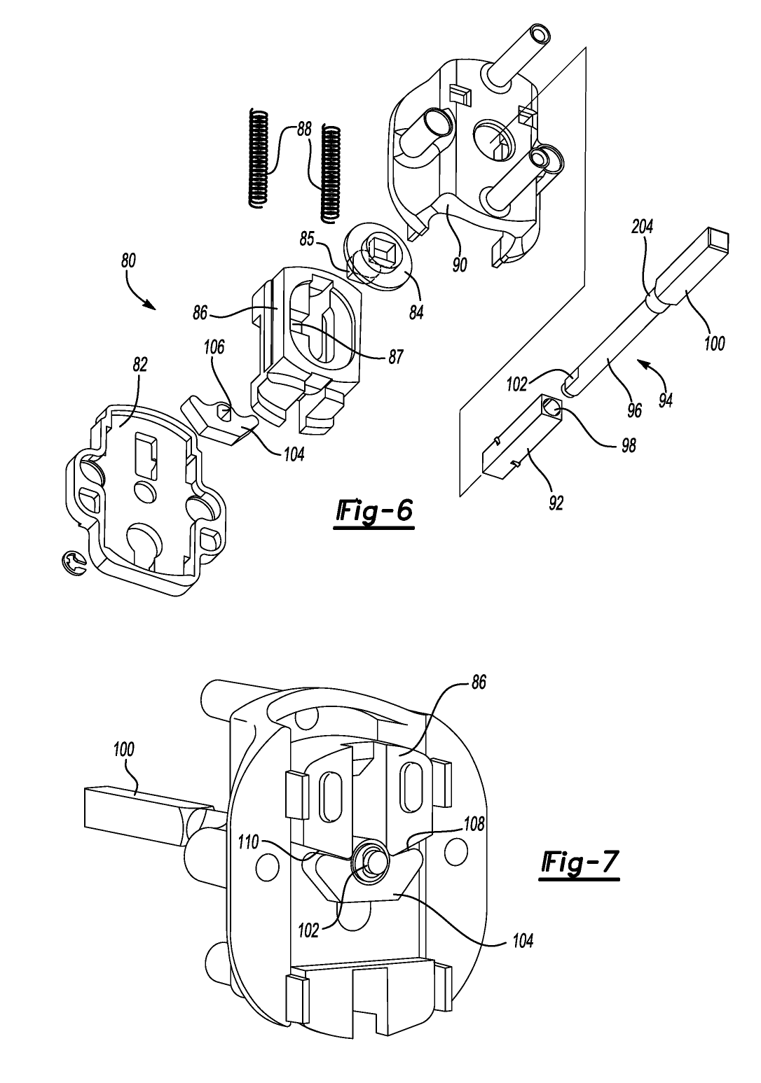

Another embodiment 80 is shown in FIG. 6. A cover plate 82 is provided along with a slider plate 86, and a rotating plate 84 having the cam 85. Again, springs 88 bias the slider plate 86 and an outer cover plate 90 is provided. In this embodiment, the spindle 94 includes a first cylindrical portion 96, and a second portion 92 having a central, cylindrical bore 98 to receive portion 96. An outer surface of second portion 92 is shown as square.

An end 100 of the spindle extends to the rotary handle (not shown). An inner end of portion 96 has flats 102. A pivoting actuation member 104 has a bore 106 that receives the flats 102.

As shown in FIG. 7, the spindle extends through the plate 90 to an inner side, and the slider plate 86 has a surface 110 in contact with ears 108 on the pivoting actuation member 104. A short, machined section 204 allows for extra door width adjustment.

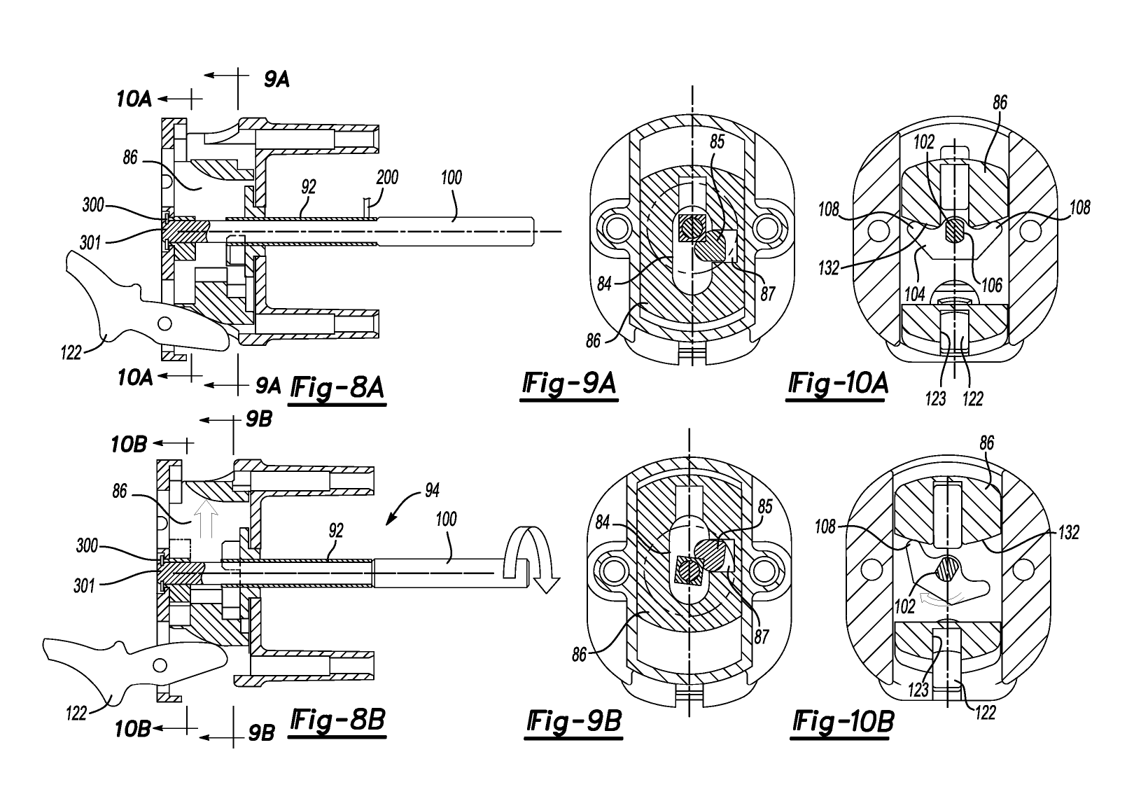

As shown in FIG. 8A, the actuation of the embodiment 80 is somewhat distinct from the actuation of the FIG. 1 embodiment. As can be compared between FIGS. 8A and 8B, when the rotary handle is turned, as shown in FIG. 8B, the slider 86 is caused to move and actuate the latch. As shown between FIGS. 8A and 8B, with this movement, the thumb latch 122 does move.

As shown in FIGS. 9A and 9B, the rotary plate has actuation similar to the earlier embodiment due to the heart-shaped cam. However, as shown in FIGS. 10A and 10B, when the spindle 100 is turned, the pivoting actuation member 104 will pivot, and one of its ears 108 will cam a surface 132 of the slider plate 86, causing the slider plate to move upwardly.

When the pivoting actuation member 104 cams the slider plate 86 upwardly as shown in this figure, the slot 87 in the slider plate 86 will cause the heart-shaped cam 85 to be driven to rotate, in turn rotating the rotary plate 84. When this occurs, the hub 200 as illustrated schematically in FIG. 8, will be actuated. Again, the hub structure utilized to actuate the latch is as known in the art, and is disclosed schematically within this application.

A slot 123 within the slider plate 86 guides the thumb latch 122. The interface surface between the thumb latch 122 and the slider plate is again curved, as can be appreciated from FIGS. 8A and 8B. Since the slider plate 86 does move when the handle is turned, the thumb latch 122 will pivot. When the thumb latch 122 is pivoted, it moves the slider plate. However, the portion 92 of the spindle 94 can pivot relative to the portion 100 in this instance. Thus, the handle does not turn when the thumb latch is actuated.

In both embodiments, a clip 300 is received on an inner end 301 of the spindle to hold the several disclosed components.

Although a preferred embodiment of this invention has been disclosed, a worker of ordinary skill in this art would recognize that certain modifications would come within the scope of this invention. For that reason, the following claims should be studied to determine the true scope and content of this invention.

1.-20. (canceled)

21. A method of operating a handleset mechanism comprising the steps of:
(1) providing a thumb latch for pivoting, providing a slider plate to be driven to slide by said thumb latch, providing a cam received within a surface on said slider plate, said cam being provided on a rotary plate, such that sliding movement of said slider plate causes rotary movement of said cam and said rotary plate, providing a shaft, and providing a latch actuation mechanism that actuates a latch when said shaft turns;
(2) pivoting said thumb latch to cause said slider plate to slide, to in turn rotate said cam and said rotary plate along with said shaft to actuate the latch.

22. The method as set forth in claim 21, further comprising the steps of providing a rotary handle for also rotating a shaft and causing actuation of said latch, and rotating said rotary handle to actuate said latch.

23. The method as set forth in claim 22, wherein said rotary handle is rotated without causing movement of said slider plate, or movement of said thumb latch.
